(19) United States
(12) Patent Application Publication
(10) Pub. No.: US 2006/0045720 A1
(43) Pub. Date: Mar. 2, 2006

(54) Method of fabricating a tall multi-stage work piece

(76) Inventor: Larry Bertelsen, Saskatchewan (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/156,810

(22) Filed: Jun. 20, 2005

(30) Foreign Application Priority Data
Aug. 26, 2004 (CA) 2,479,412

(51) Int. Cl. B66C 23/00

(52) U.S. Cl. 414/744.5

(57) ABSTRACT

A method of fabricating a tall multi-stage work piece. A vertical shaft is provided extending below ground at a permanent fabrication facility. An elevator platform is provided in the shaft. The elevator platform is adapted to lower a work piece into and lift the work piece out of the shaft. At least one above ground work station is provided at the upper end of the shaft. A work piece is placed on the elevator platform. The elevator platform is then lowered as each stage of the work piece is completed, in order to maintain a desired working height for workers at the above ground work station. The elevator platform is raised and the work piece is removed from the elevator platform, when fabrication is complete.

### FIELD OF THE INVENTION

The present invention relates to a method of fabricating a tall multi-stage work piece and, in particular a method of fabricating a bulk storage container, such as a fuel tank or a granary.

### BACKGROUND OF THE INVENTION

The patent literature discloses various methods which have been developed with a view to fabricating bulk storage containers in a safer or more efficient manner. Japanese patent JP7034711 (Yoshiwaka et al 1995) discloses a method of fabricating an underground storage tank in situ. In accordance with the teachings of the Yoshiwaka patent, an excavation of an appropriate depth is filled with water. A bottom portion of an underground storage tank, made of thin metal, is caused to float in the excavation. A series of drum units making up the underground storage tank are then joined. As the drum units are attached, the underground storage tank is sunk in stages; until the underground storage tank rests upon the bottom of the excavation. The buoyancy of the water is used to support the structure during welding and permit the controlled lowering of the structure into the excavation.

### SUMMARY OF THE INVENTION

The present invention relates to a method of fabricating a tall multi-stage work piece, such as a bulk storage tank, that utilizes an excavation.

According to the present invention there is provided a method of fabricating a tall multi-stage work piece. A vertical shaft is provided extending below ground at a permanent fabrication facility. An elevator platform is provided in the shaft. The elevator platform is adapted to lower a work piece into and lift the work piece out of the shaft. At least one above ground work station is provided at the upper end of the shaft. A work piece is placed on the elevator platform. The elevator platform is then lowered as each stage of the work piece is completed, in order to maintain a desired working height for workers at the above ground work station. The elevator platform is raised and the work piece is removed from the elevator platform, when fabrication is complete.

The method of fabrication, described above, completely eliminates the need to place scaffolding around a work piece, to establish a desired working height, as fabrication progresses. This saves time and money. It also provides a safer working environment by eliminating dangers associated with working at heights, such as the danger of falling, the danger of dropping tools, and the danger of becoming tangled in hose or cable extensions.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a partially cut away perspective view of a fabrication station constructed in accordance with the teachings of the present invention.

FIG. 2 is a side elevation view, in section, of the fabrication station illustrated in FIG. 1.

FIG. 3 is a side elevation view, in section, of a turntable illustrated in FIG. 1.

FIG. 4 is a top plan view of the fabrication station illustrated in FIG. 1.

FIG. 5 is a top plan view of a fabrication station with an alternative embodiment of elevator platform.

FIG. 6 is a side elevation view, in section, of the fabrication station illustrated in FIG. 5.

### DETAILED DESCRIPTION OF THE PREFERRED EMBODIMENT

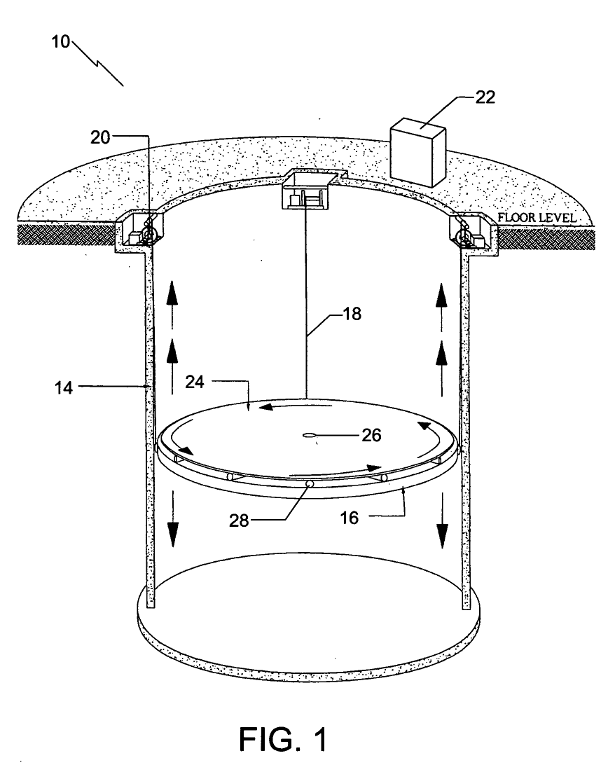

The preferred embodiment, a fabrication station generally identified by reference numeral 10, will now be described with reference to FIGS. 1 through 4.

Structure and Relationship of Parts:

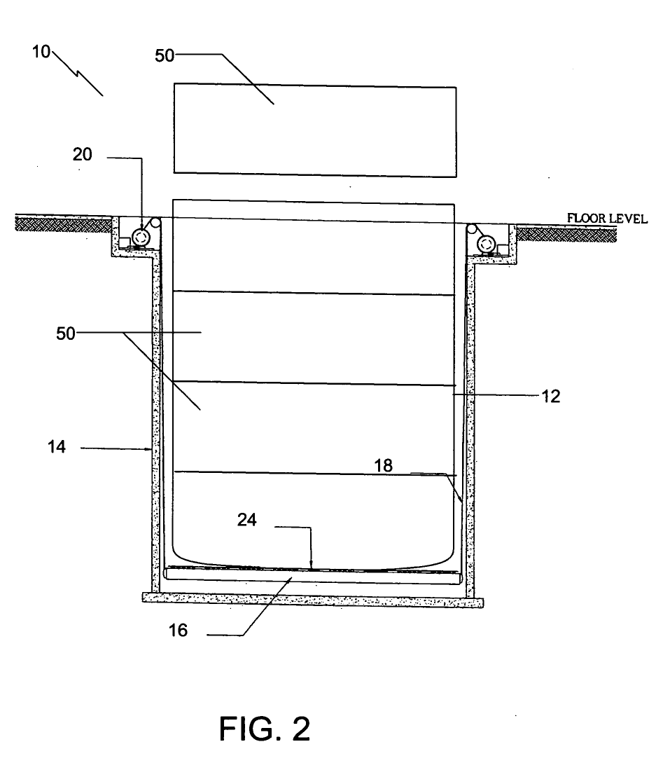

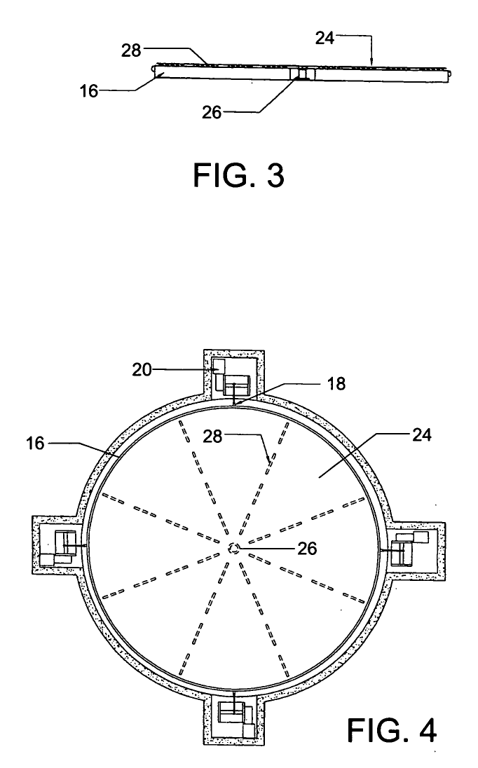

Referring to FIG. 2, there is shown fabrication station 10 for fabricating a tall multi-stage work piece 12. Fabrication station 10 includes a vertical shaft 14 extending below ground at a permanent fabrication facility. An elevator platform 16 is located in shaft 14, such that elevator platform 16 is adapted to lower work piece 12 into and lift work piece 12 out of shaft 14. Elevator platform 16 is suspended by cables 18 and lowered or raised by means of winches 20. Referring to FIG. 1, an above ground work station 22 is located at the upper end of shaft 14, such that work piece 12 on elevator platform 16 is lowered as each stage of work piece 12 is completed in order to maintain a desired working height for workers at above ground work station 22. For improved efficiency, more than one above ground work station 22 may be included at points around shaft 14. Referring now to FIG. 3, a turntable 24 is positioned on elevator platform 16, such that turntable 24 is rotated as required during fabrication to provide improved access to work piece 12 for workers at above ground work station 22. Referring now to FIG. 4, turntable 24 may be rotated, for example, by an orbital motor 26 and rollers 28. Once fabrication is complete, elevator platform 16 is raised to remove work piece 12 from elevator platform 16 and shaft 14.

Operation:

The use of fabrication station 10 to fabricate a tall multi-stage work piece 12 will now be discussed with reference to FIGS. 1 through 4. Referring to FIG. 2, work piece 12 is constructed from a number of stages 50. Fabrication begins with one of stages 50 being placed onto elevator platform 16 which is in vertical shaft 14 that extends below ground at a permanent fabrication facility. Elevator platform 16 lowers work piece 12 into shaft 14 as more stages 50 are added to work piece 12. In the illustrated embodiment, the lowering of elevator platform 16 is accomplished by means of winches 20 and cables 18. Elevator platform 16 is lowered to maintain the height of work piece 12 at an optimal height for workers. Referring to FIG. 1, work is completed at above ground work station 22 located at the upper end of shaft 14. As work progresses on each stage, work piece 12 is rotated. The rotation of work piece 12 enables workers access around the entire circumference of work piece 12. This rotation is accomplished by means of turntable 24, which is moved by orbital motor 26 and rollers 28. Once work is completed, work piece 12 is raised out of shaft 14 on platform 16 by cables 18 and winches 20.

The present invention is viewed as providing a number of advantages. It is believed that this method of fabrication will prove to be vastly more efficient than other methods which require the erection of scaffolding as sections are added. Every year there are numerous accidents involving scaffolding. It is believed that this method of fabrication will eliminate such accidents.

Variations:

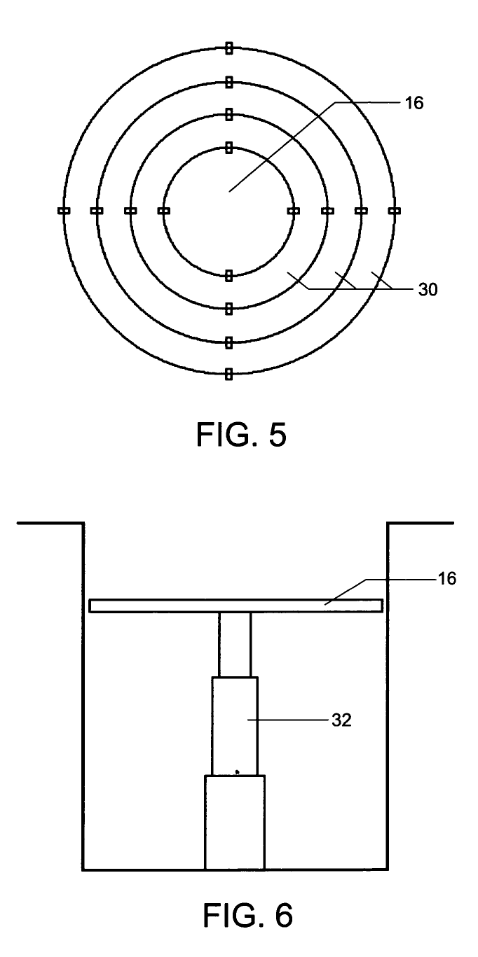

Referring to FIG. 5, the diameter of elevator platform 16 is adjustable to suit different sizes of work piece. As shown, there are three additional sections 30, although any convenient number of sections 30 may be used, which can be either attached to platform 16 to increase its diameter, or to the ground around shaft 14. Referring to FIG. 6, in order to facilitate diameter changes to elevator platform 16, elevator platform 16 is supported from below by a telescopic column 32 and is raised or lowered by means of hydraulics.

It will be appreciated by one skilled in the art that any vessel or work piece can be accommodated that would otherwise require scaffolding or lifting of workers by crane or man basket. In addition to the obvious safety benefits and cost savings, work can be conducted in a smaller work area, as there is no prefabrication required, no manoeuvring of cranes or scaffolding and less congestion overall.

Variations:

It is not practical to illustrate all possible variations to the present invention. A further alternative to the winches and cables or hydraulic embodiments illustrated, one could raised and lower the elevator platform using air bags. Similarly, the work stations could take various forms, such as robotic welding, working gangways, etc. When the elevator platform has a variety of diameters, each of those diameters could be equipped with individual orbiting motors. It is also possible to utilize the present invention in combination with other manufacturing processes. For example, material could be fed directly into the work area. With metal structures, there could be vertical steel plate rollers feeding steel plate into the work area.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

1. A method of fabricating a tall multi-stage work piece, comprising the steps of:
providing a vertical shaft extending below ground at a permanent fabrication facility;
positioning an elevator platform in the shaft, the elevator platform being adapted to lower a work piece into and lift the work piece out of the shaft;
providing at least one above ground work station at the upper end of the shaft;
placing a work piece on the elevator platform;
lowering the elevator platform as each stage of the work piece is completed in order to maintain a desired working height for workers at the at least one above ground work station; and
raising the elevator platform and removing the work piece from the elevator platform when fabrication is complete.

2. The method as defined in claim 1, including the further step of providing a turntable on the elevator platform and rotating the turntable as required during fabrication to provide improved access to the work piece for workers at the at least one above ground work station.

3. The method as defined in claim 1, the elevator platform being suspended by cables and lowered or raised by means of winches.

4. The method as defined in claim 1, wherein the diameter of the elevator platform is adjustable to suit different sizes of work piece.

5. The method as defined in claim 4, wherein the elevator is supported from below by a telescopic column and is raised or lowered by means of hydraulics.

6. A fabrication station for a tall multi-stage work piece, comprising:
a vertical shaft extending below ground at a permanent fabrication facility;
an elevator platform in the shaft, the elevator platform being adapted to lower a work piece into and lift the work piece out of the shaft; and
at least one above ground work station at the upper end of the shaft, such that a work piece on the elevator platform is lowered as each stage of the work piece is completed in order to maintain a desired working height for workers at the at least one above ground work station.

7. The fabrication station as defined in claim 6, wherein a turntable is positioned on the elevator platform, such that the turntable is rotated, as required, during fabrication to provide improved access to the work piece for workers at the at least one above ground work station.

8. The fabrication station as defined in claim 6, wherein the elevator platform is suspended by cables and lowered or raised by means of winches.

9. The fabrication station as defined in claim 6, wherein the diameter of the elevator platform is adjustable to suit different sizes of work piece.

10. The fabrication station as defined in claim 9, wherein the elevator is supported from below by a telescopic column and is raised or lowered by means of hydraulics.
